(19) United States
(12) Patent Application Publication
(10) Pub. No.: US 2003/0077060 A1
(43) Pub. Date: Apr. 24, 2003

(54) Planar lightwave circuit optical waveguide having a circular cross section

(76) Inventors: Datong Chen, Fremont, CA (US); Brian E. Lemoff, Union City, CA (US); Charles D. Hoke, Menlo Park, CA (US); Julie E. Fouquet, Portola Valley, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/000,530

(22) Filed: Oct. 23, 2001

(51) Int. Cl. G02B 6/10

(52) U.S. Cl. 385/129

(57) ABSTRACT

An optical device for planar lightwave circuits and a method of making the same provide a waveguide with a core having a cylindrical shape and a more circular than rectangular cross section that is viewed perpendicular to an optical path formed by the optical waveguide. The optical device comprises a planar substrate having a peripheral index of refraction and the waveguide formed in the substrate. The waveguide has a core index of refraction that is greater than the peripheral index of refraction. The method of making the optical waveguide in a planar substrate comprises forming the waveguide core within the substrate such that the waveguide core has an index of refraction within the cross section that is higher than an index of refraction in a cladding region. The cladding region of the substrate surrounds the core. Furthermore, the core cross section can vary along its length to provide an optical mode transformer.

### TECHNICAL FIELD

The invention relates generally to optical waveguides. In particular, the invention relates to optical waveguides in planar lightwave circuits.

### BACKGROUND ART

An integral part of many optically based telecommunication and data networking systems is a planar lightwave circuit (PLC). A PLC is a circuit fabricated on top of and/or within a planar substrate that has one or more integrated optical waveguides. Along with the optical waveguides, many PLCs also have electrical conductors and in some cases, both passive and active electronic and optical elements integrated into the planar substrate. The primary role of most PLCs is to provide a means for interconnecting optical and optoelectronic components to one another. In addition, PLCs often provide interconnection between purely electronic components and the optical/optoelectronic components. Besides hosting and interconnecting components, PLCs also often furnish a means for interfacing optical fibers to the PLC circuitry. The role of the PLC in interfacing optoelectronic circuitry to optical fibers is particularly important since optical fibers typically serve as the principal optical transmission medium for carrying the optical data signals between portions of the optoelectronic systems. A wide variety of optical and optoelectronic system elements including switches, couplers, optical frequency multiplexers, and optical transceivers are routinely implemented using PLCs.

The optical waveguide in a PLC substrate is a dielectric waveguide similar in concept to an optical fiber. The waveguide is made up of a core surrounded by a cladding layer or region. The core has an index of refraction n₁ that is higher than an index of refraction n₂ of the cladding region surrounding the core. In some PLCs, the core and cladding are constructed from the same material, namely a substrate material of the PLC. When the same material is used for the core and cladding, the difference in the indices of refraction of the core and cladding is most often produced by selective differential doping. Selective differential doping is the selective introduction of differing concentrations of impurities or dopant ions into the material during substrate manufacture. In other cases, the core and cladding are constructed from different materials that are often deposited sequentially on a substrate or carrier. The materials are chosen so that they have, among other properties, a desired difference in refractive indices to create the core and cladding layers.

In most instances, it is preferable to surround the core with a uniform or relatively homogeneous dielectric cladding region. Surrounding the core with a uniform dielectric cladding region provides for better waveguide performance. In particular, a homogeneous cladding region surrounding the core reduces dispersion and optical signal loss and leakage. However, there are exceptions when two or more different cladding materials are found surrounding a single core. An example of this exception is found in a PLC where the optical waveguide runs along a surface of the planar substrate. The cladding below the waveguide core is the substrate while the cladding above the core is air.

FIGS. 1A, 1B and 1C illustrate examples of three optical waveguide core/cladding configurations used in conjunction with PLCs. The optical waveguides in FIGS. 1A, 1B and 1C are illustrated in a cross section that is perpendicular to an optical path through the waveguide. FIG. 1A illustrates a so-called buried optical waveguide 10 in which the guide is located entirely within a planar substrate 12. A waveguide core 14 having an index of refraction n₁ that is higher than that of the index of refraction n₂ of the surrounding substrate material is formed below a top surface 16 of the substrate 12. Either the substrate 12 itself or a specially treated region surrounding the core 14 acts as the cladding 18.

The optical waveguide 20 illustrated in FIG. 1B is formed on a top surface 24 of a planar substrate 22 typically through the deposition of one or more epitaxial layers. As with the buried waveguide 10, the optical waveguide 20 has a core 26 and a cladding layer 28. The cladding 28 surrounds the core 26. In some cases (not illustrated), the cladding layer 28 only caps the core 26. In these cases, the substrate 22 acts as a portion of the cladding layer 28 adjacent to the core 26. In yet other cases, air may act as the cladding layer 28 along one or both sides of the core 26 in this kind of PLC optical waveguide.

The third type of optical waveguide 30 illustrated in FIG. 1C comprises a core 32 formed in a top surface 34 of a planar substrate 36. The optical waveguide 30 employs the substrate 36 or a specially treated region of the substrate 36 below and to the sides of (adjacent to) the core 32 as a cladding layer 37. In addition, air above the core 32 also acts as part of a cladding layer 38. Optical waveguides 30 in the surface 34 of a substrate 36 are formed either by machining and back-filling a groove in the surface 34 or by selective diffusion doping. Selective diffusion doping comprises selectively depositing a dopant on the surface 34 and then diffusing the dopant into the substrate 36. The result is an optical waveguide having core 32 with a graded index of refraction and a roughly half-cylinder shaped cross section.

In general, optical waveguides in PLCs, such as those illustrated in FIGS. 1A, 1B and 1C, are fabricated using standard photolithographic based semiconductor and printed circuit board manufacturing methodologies. A number of optical waveguide fabrication methodologies applicable to PLCs are known in the art. For example, Kovacic et al., U.S. Pat. No. 5,917,981, disclose a channel waveguide structure that can be incorporated into very large scale integrated (VLSI) circuits using a silicon germanium (SiGe) alloy core and silicon (Si) top and bottom cladding. Kaiser, U.S. Pat. No. 4,070,516, discloses a method of manufacturing a multilayer ceramic module structure that includes a buried glass optical waveguide channel. A method of producing stacked optical waveguides in a silicon dioxide substrate using rectangular trenches etched in the substrate is disclosed by Lee et al., U.S. Pat. No. 5,281,305. Nijander et al., U.S. Pat. No. 5,387,269, disclose an optical waveguide made by forming successive layers of a first cladding material layer, a light transmitting material layer, and second cladding material layer on top of a substrate. Similarly, Bhandarkar et al. disclose a method of forming an optical waveguide as layers on top of a substrate, the cladding and core layers composed of deposited particulate glass that is consolidated by viscous sintering to produce the waveguide structures. In a slightly different approach, Jang et al., U.S. Pat. No. 6,177,290, disclose a method of fabricating a planar optical waveguide on top of a substrate that can be performed in a single processing chamber. With the exception of the half-cylinder shaped guide illustrated in FIG. 1C formed by the diffusion-based method, all of the methods known in the art for fabricating optical waveguides that are applicable to PLCs including, but not limited to, those listed hereinabove, produce a waveguide in which the core has an essentially rectangular cross section. Thus, typical core cross sections found in PLCs have shapes ranging anywhere from a square to a low aspect ratio rectangle and a half-cylinder.

Unfortunately, the rectangular to square shapes and the half-cylinder shape of the conventional PLCs optical waveguides known in the art present a problem when it comes to interfacing the PLC to optical fibers. Optical modes within the conventional PLC optical waveguides have a largely non-circular shape. On the other hand, the core of the standard optical fiber is generally cylindrical having a circular cross section that results in circularly shaped optical modes within the fiber. Thus, when attempting to couple or interface the optical fiber to an optical waveguide in a PLC, there is an optical mode mismatch between optical modes of the conventional optical waveguide in the PLC and the circular optical modes of the standard optical fiber. This mode mismatch leads to loss of optical power at the interface. While in some applications, power loss associated with the mismatch can be tolerated, the mismatch and resulting power loss always unfavorably impact the system performance to some extent. In fact, in many applications the negative impact of the mismatch loss is so severe that it warrants the use of specialized interfacing structures such as lenses to help mitigate the affects of the mismatch loss.

In addition, optical waveguides that have non-uniform cladding layers such as those of the type illustrated in FIG. 1C and others described hereinabove are subject to higher transmission losses, increased dispersion, and related distortion effects. The higher losses and increased dispersion of such guide structures further exacerbate the problems associated with using these guide structures in many PLCs applications.

Accordingly, it is desirable to have an optical waveguide for a PLC that can provide for lower power loss at the couplings between PLC waveguides and optical fibers, has good optical signal propagation characteristics, and is economical to manufacture or produce. Such an optical waveguide and method of producing it would solve a long-standing need in the area of PLCs for optical communications.

### SUMMARY OF THE INVENTION

The present invention provides an optical waveguide and method of making an optical waveguide in a substrate for planar lightwave circuit (PLC) applications. The optical waveguide of the present invention has a core with a substantially circular cross section when viewed perpendicular to the optical path. In other words, the optical waveguide has a cross section that is at least more circular than rectangular. The core shape provides for a better optical mode match between the PLC waveguide and an optical fiber for coupling. Furthermore, the core of the optical waveguide of the present invention is buried or located within a planar substrate of the PLC. The buried nature of the guide provides good optical signal propagation characteristics due to a relative homogeneity of a cladding layer dielectric surrounding the core of the waveguide. Moreover, the method of making the buried optical waveguide of the present invention can employ, in part, well-known fabrication techniques.

In one aspect of the invention, a planar lightwave circuit optical device is provided. The optical device of the present invention comprises an optical waveguide located or buried within a PLC substrate. The planar substrate has a peripheral index of refraction. The waveguide has a core with a cross section that is more circular than rectangular. Further, the waveguide has a core index of refraction that is greater than the peripheral index of refraction of the substrate. The substrate essentially is a homogenous cladding layer surrounding the core.

In another aspect of the present invention, a method of making an optical waveguide in a planar substrate is provided. The method comprises forming a waveguide core having a cross section that is more circular than rectangular within the planar substrate such that the waveguide core has an index of refraction within the cross section that is higher than an index of refraction in a cladding region of the planar substrate surrounding the core. Advantageously, the waveguide formed by the method of making of the present invention has a substrate cladding region that is relatively homogenous.

The waveguide core can be formed in several ways according to the invention. Depending on the embodiment, the core may be formed using ion implantation and diffusion, or shaping the planar substrate and using either or both of selective additive and selective subtractive deposition processes, for example, that are well known in the art.

In yet another aspect of the invention, an optical mode transformer is provided. The mode transformer adapts a non-circular conventional PLC waveguide to a circular optical fiber. The mode transformer comprises a planar substrate and an optical waveguide formed in the planar substrate that has a cross section that varies in shape along its length. In particular, the cross section transitions, preferably smoothly, from a non-circular cross section to a substantially circular cross section. Such a mode transition or adaptor facilitates interfacing conventional PLC optical guides to optical fibers, thus reducing power loss at an interface.

The present invention provides for the economical manufacture of waveguides with substantially circular cross sections that are more circular than rectangular in planar substrates. The substantially circular cross section facilitates a better optical mode match with a connecting optical fiber than is provided by conventional optical guides for PLCs, thus reducing power losses at a fiber-waveguide interface. In addition, the present invention provides a relatively homogeneous cladding layer that promotes low loss and low dispersion propagation of optical signals within the guide. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1A illustrates a cross section of a conventional optical waveguide in a planar lightwave circuit substrate of the prior art.

FIG. 1B illustrates a cross section of another conventional optical waveguide on a planar lightwave circuit substrate of the prior art.

FIG. 1C illustrates a cross section of still another conventional optical waveguide in a planar lightwave circuit substrate of the prior art.

FIG. 2 illustrates a buried optical waveguide of the present invention in a cross section perpendicular an optical path.

FIG. 3 illustrates a flow chart of a method of forming a buried optical waveguide having a cylindrical core with graded index of refraction for a PLC according to the present invention.

FIG. 4A illustrates a cross section of a substrate with an implanted doped linear region, the cross section being perpendicular to a waveguide path in accordance with the present invention.

FIG. 4B illustrates a cross section of a planar substrate with an implanted doped linear region, the cross section being parallel to a waveguide path in accordance with the present invention.

FIG. 4C illustrates the same cross section as FIG. 4A after the step of diffusing in accordance with the present invention.

FIG. 4D illustrates the same cross section as FIG. 4B after the step of diffusing in accordance with the present invention.

FIG. 5 illustrates an index of refraction profile depicting the typical variation in the local index of refraction n₁(d) as a function of distance d from the center of the cylindrical core produced by the method illustrated in FIG. 3.

FIG. 6 illustrates a flow chart of another method of forming a buried optical waveguide of the present invention.

FIG. 7A illustrates in cross section a planar substrate having semi-circular grooves created in a top portion and a bottom portion of the substrate in accordance with the invention.

FIG. 7B illustrates in c ross section the grooves of FIG. 7A that have been filled in accordance with the method illustrated in FIG. 6.

FIG. 7C illustrates in cross section the substrate portions of FIG. 7B after the step of attaching in accordance with the method illustrated in FIG. 6.

FIG. 8 illustrates a flow chart of yet another method of forming a buried optical waveguide of the present invention.

FIG. 9A illustrates in cross section a planar substrate having a semi-circular groove created in a bottom portion of the substrate in accordance with the method illustrated in FIG. 8.

FIG. 9B illustrates in cross section the result of the step of depositing the core material on the bottom portion of the substrate of FIG. 9A in accordance with the method illustrated in FIG. 8.

FIG. 9C illustrates a cross section of the substrate of FIG. 9B after the step of removing in accordance with the method illustrated in FIG. 8.

FIG. 9D illustrates in cross section the substrate of FIG. 9C after the step of applying an upper cladding in accordance with the method illustrated in FIG. 8.

### MODES FOR CARRYING OUT THE INVENTION

The present invention is an optical waveguide device and a method for making or forming an optical waveguide in a substrate of a planar lightwave circuit (PLC). The optical device of the present invention has a waveguide core that is essentially cylindrical in shape and has a substantially circular cross section. The substantially circular cross section of the optical waveguide facilitates coupling the optical waveguide to optical fibers. The optical waveguide of the present invention can be operated as either a multimode or single mode optical guide. Furthermore, the method of making can produce optical waveguides having specifically tailored shapes for various optical coupling and related purposes.

Herein, a two-dimensional shape, such as a cross section, is ‘substantially circular’ or ‘more circular than rectangular’ if and only if an area of a smallest circle enclosing the shape is less than an area of a smallest rectangle enclosing the shape. Thus, the core of the waveguide of the present invention can have a cross section perpendicular to an optical path through the core that ranges from purely circular to elliptical and even to rectangular with rounded corners (including square with rounded comers). For simplicity of discussion hereinbelow, the terms ‘substantially’ and ‘essentially’ with respect to the ‘circular’ and ‘cylindrical’ core shape are omitted, while preserving the full scope of the definitions provided above therefor.

Also herein, a PLC is a circuit fabricated on top of and/or within a planar substrate that has one or more integrated optical waveguides. The PLC substrate is referred to as being ‘planar’ by those skilled in the art. The term ‘planar’ when used with the term ‘substrate’ herein has the same meaning as that understood by those skilled in the art. Generally, a planar substrate means that opposite major surfaces of the substrate are parallel planes, when each major surface is considered as a whole (i.e., not including surface texture, imperfections and/or roughness). Thus, an optical fiber is neither a PLC nor an optical waveguide in a PLC substrate. A PLC may range from a simple device used to carry an optical signal across the planar substrate to a complex device that integrates electronic, optoelectronic, and optical components onto or into a single structure. Generally, although not always, a PLC is fabricated using conventional semiconductor fabrication technologies including photolithography. One skilled in the art is familiar with PLCs, their manufacture, and their use.

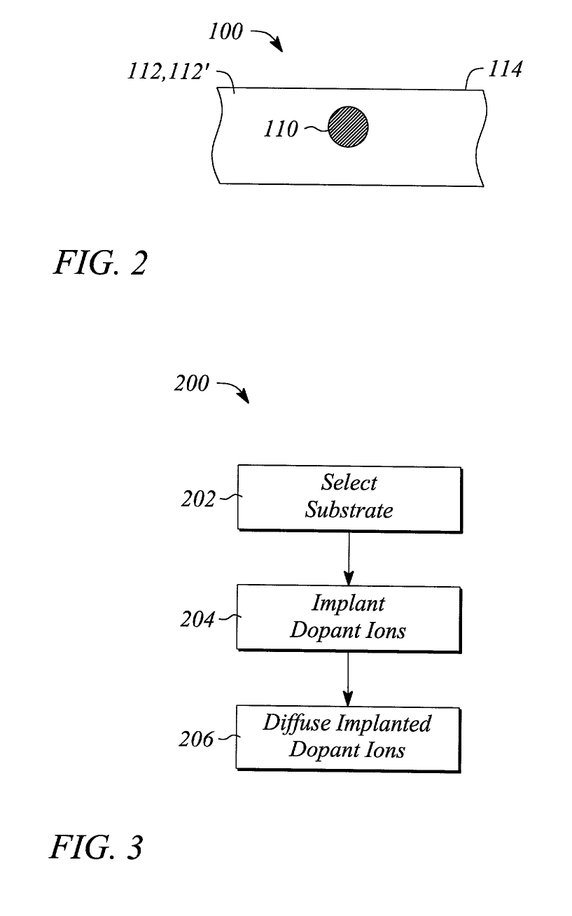

In one aspect of the invention, a buried optical waveguide 100 having a cylindrical core is provided. The buried optical waveguide of the present invention is illustrated in FIG. 2 as a cross section perpendicular to an optical path through the waveguide. The optical waveguide 100 comprises a core 110 having a circular cross section. The core 110 is located within a planar substrate 112 such that the core 110 is below a top surface 114 of the substrate 112. The substrate 112 can be a substrate of a PLC. For the purposes of discussion herein, the substrate 112 can be either a simple bulk planar substrate 112 as illustrated in FIG. 2 or a bulk planar substrate 112′ with a planar epitaxial layer (not illustrated) applied to the top surface 114 of the substrate 112. Thus, the core 110 of the present invention can be located within either the bulk substrate 112 or the epitaxial layer of the bulk substrate 112′. As used herein, the terms ‘top’, ‘bottom’ and ‘side’ are relative orientations only and not intended as limitations to the invention. The core 110 is located, or completely embedded, within the substrate 112, or the epitaxial layer of the bulk substrate 112′, such that the core 110 does not intersect any boundary defining the shape of the substrate 112 or of the epitaxial layer of the bulk substrate 112′.

The optical waveguide 100 further comprises a cladding layer or region surrounding the core 110. Preferably, a region of the substrate 112 in the vicinity of and surrounding the core 110 serves as the cladding layer of the optical waveguide 100. The core 110 has an index of refraction n₁ that is greater than an index of refraction n₂ of the cladding layer. When a bulk substrate 112′ with an epitaxial layer is used as the substrate 112, the cladding layer can be portions of both or all of either the bulk substrate 112′ and the epitaxial layer. However, it is preferred that the core 110 be either entirely in the bulk substrate 112′ or entirely in the epitaxial layer to minimize any effects of a material inhomogeneity in the cladding layer associated with an interface between the epitaxial layer and the bulk substrate 112′. Materials for use in the optical waveguide 100 along with a variety of methods of forming the optical waveguide are discussed in detail hereinbelow.

In another aspect of the present invention, a method for making an optical waveguide in a planar substrate is provided. The method comprises forming a waveguide core having a cross section that is more circular than rectangular within the planar substrate, such that the waveguide core has an index of refraction that is higher than an index of refraction in a cladding region of the planar substrate. The cladding region surrounds the core. The waveguide can be formed by one or more methods according to the invention that are described in detail below.

FIG. 3 illustrates a flow chart of a method 200 of forming a buried optical waveguide having a cylindrical core of the present invention. The method 200 forms an optical waveguide that is buried below surface of a planar substrate or below a surface of a planar epitaxial layer on the surface of the substrate. The optical waveguide core is created by implanting and diffusing dopant ions that control the index of refraction of the substrate in the core. Alternatively, a thin film deposition methodology followed by photolithographic definition, etching, covering and diffusing is used. The diameter of the cylindrical core can be controlled.

The method 200 of forming a buried optical waveguide comprises the step of selecting 202 a substrate. For the purposes of discussion, the term ‘substrate’, as used herein, will refer to both a bare planar substrate and to a substrate with one or more planar epitaxial layers applied to its surface unless otherwise noted. Thus, the buried optical waveguide of the present invention may be located within either the substrate material or within the epitaxial layer(s) on the substrate surface without altering the discussion hereinbelow.

A suitable substrate is one in which a dopant introduced into the substrate and/or the epitaxial layers on the substrate surface can be used to define an optical guiding structure. As such, the substrate desirably has good optical properties and preferably, is either a dielectric or semiconductor material, such that a dopant concentration therein controls a dielectric constant or index of refraction of the substrate material.

In addition, the substrate preferably is one in which diffusion of the dopant can be initiated and terminated in a controlled manner during waveguide fabrication. For example, a suitable substrate is one in which diffusion of a dopant can be controlled by subjecting the substrate to a controlled, high temperature regime. In other words, the rate of dopant diffusion in a suitable substrate is rapid when the substrate is subjected to a high temperature and relatively much slower when the substrate is subjected to temperatures consistent with an operating temperature range of the PLC. Thus, to promote diffusion, the substrate temperature is raised to a high temperature and to terminate diffusion the substrate temperature is returned to an ambient or room temperature. One skilled in the art would be familiar with such temperature related diffusion characteristics of typical substrate materials. Examples of applicable substrate materials include, but are not limited to, mono- and poly-crystalline silicon (Si), silicon with a silicon dioxide (SiO₂) epitaxial layer, gallium arsenide (GaAs), indium phosphate (InP) lithium niobate (LiNbO₃), and silica and boro-silicate glasses, and various optically compatible ceramics.

In general, the selection of a specific dopant is related to or perhaps even dictated by the choice of substrate material. For example, for a SiO₂ substrate, boron ions are often used as a dopant. In the case of a pure, mono-crystalline Si substrate, germanium (Ge) ions can be used. One skilled in the art would be able to determine an appropriate dopant for a given substrate material and PLC application without undue experimentation. The method 200 of forming a buried cylindrical optical waveguide further comprises the step of implanting 204 dopant ions in the substrate. Once implanted 204, the doped region preferably has a concentration profile characterized by a narrow width and height located at a predefined depth in the substrate. In other words, the step of implanting 204 creates a highly concentrated doped region having a linear shape or profile within the substrate. Ideally, a high concentration of implanted dopant is confined to a very small, thin region within the substrate, wherein the doped region approximates a 2-dimensional line of dopant ions. The doped linear region is much smaller in diameter than a core diameter of the buried optical waveguide being formed and follows an eventual path of the buried cylindrical optical waveguide. The dopant concentrations in the linear doped region formed by the step of implanting 204 are much higher than an eventual dopant concentration of the core of the buried optical waveguide. In practice, the diameter of the linear doped region is preferably less than about 1 μm and the dopant concentration is between 10²¹ and 10²³/cm³. Dopant concentration after diffusion will be sufficient to produce a refractive index high enough such that the core can guide the optical signal. Preferably, the dopant concentration before diffuision is given by a final or post-diffusion dopant concentration multiplied by a final cross section area divided by an initial cross section area.

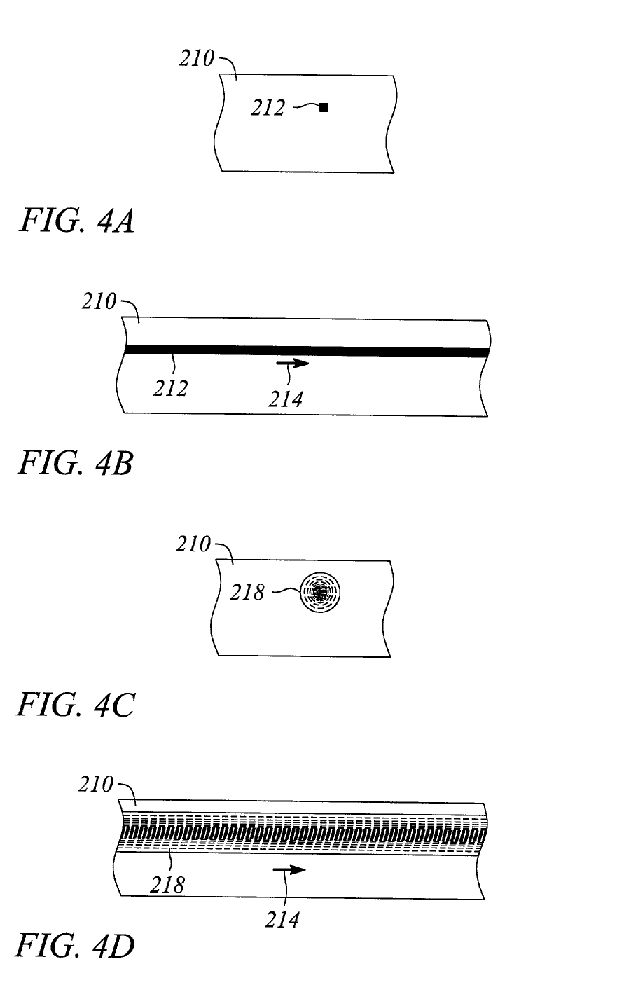

FIG. 4A illustrates a cross section of a substrate 210 with an implanted doped linear region 212 produced by the step of implanting 204, wherein the cross section is perpendicular to the path of the optical guide. FIG. 4B illustrates a cross section of the substrate 210 with the implanted doped linear region 212, wherein the cross section is parallel to the direction 214 of the optical path (indicated by an arrow) of the optical guide.

The step of implanting 204 can be accomplished by any one of several standard semiconductor and/or PLC fabrication techniques. In one such technique for example, a mask material is applied to the surface of the substrate. Using standard photolithography, a pattern corresponding to the path of the linear doped region is defined in the mask. Dopant implantation is accomplished by bombarding the masked substrate with dopant ions that have been accelerated to a collective, known energy level. Dopant ions that impact the portion of the substrate that is covered by the mask are blocked and do not reach the substrate. Dopant ions that hit the portion of the substrate exposed by the mask penetrate the substrate surface. The depth of penetration of a given ion depends on its respective energy level. Thus, by collectively controlling the energy of the accelerated dopant ions, most of the dopant ions that impact on the exposed substrate surface will penetrate into the substrate to approximately the same depth. The example of a technique for performing the step of implanting 204 described hereinabove is sometimes referred to as ‘ion gun’ implantation and is well known in the art of semiconductor fabrication.

In a preferred technique, the doped linear region 212 is implanted 204 by depositing a material on the substrate from which the doped linear region 212 is then formed and covering the deposited material. For this preferred technique, the material is made from a bulk material comprising various powders that usually are pre-mixed and melted together. The bulk material has an appropriate index of refraction, or equivalently an appropriate dopant concentration, for the linear doped region 212. The pre-mixed bulk material is deposited on the substrate using sputtering or another thin film deposition technique known in the art. Following deposition, one or more of various photolithographic definition and etching methodologies are used to define or ‘pattern’ the deposited material. The patterned, deposited material defines a shape of the eventual implanted doped linear region 212. The patterned, deposited material is then covered with an epitaxial material layer. Preferably, the epitaxial layer used to cover the patterned, deposited material has similar mechanical and optical properties to that of the substrate 210. More preferably, the epitaxial layer used to cover the patterned, deposited material is the same material as the substrate 210. Once covered, the patterned, deposited material is the implanted linear doped region 212 within the substrate 210.

The method 200 of forming a buried cylindrical optical waveguide further comprises the step of diffusing 206 the implanted dopant ions. The step of diffusing 206 induces the implanted dopant ions to migrate or diffuse away from the doped linear region 212. The movement of the ions is essentially isotropic with respect to concentration. The ions generally move from areas of high concentration to low concentration during the step of diffusing 206. Thus, the step of diffusing 206 results in the formation of a cylindrically shaped region of doped substrate material that surrounds equally in all directions what previously had been the doped linear region 212 of the step of implanting 204. Furthermore, the cylindrical doped region of the substrate has a refractive index n₁ that is generally higher than the refractive index n₂ of a region of the substrate outside the doped cylindrical region. The higher index of refraction n₁ in the doped region is due to the presence of the dopant ions implanted 204 before diffusion 206. Thus, the doped cylindrical region forms a cylindrical core of the optical waveguide, wherein an optical signal is guided by the difference in refractive indices n₁, n₂ inside and outside the cylindrical doped region, respectively.

The step of diffusing 206 is normally accomplished by heating the substrate to a high temperature and holding the substrate at the high temperature for a predetermined period of time. In general, the higher the temperature the faster the ions move. The longer the substrate is held at the high temperature, the larger the diameter of the resultant cylindrical core. Rates of diffusion for given dopant ion and substrate concentrations, as well as optimum diffusion temperatures, are well known in the art. Moreover, one skilled in the art would readily be able to determine a suitable temperature and hold time for producing a desired core size without undue experimentation.

FIG. 4C illustrates the same cross section as in FIG. 4A after the step of diffusing 206 that shows the cylindrical doped region 218 of a resulting optical waveguide. FIG. 4D illustrates the same cross section as in FIG. 4B after the step of diffusing 206 that shows the cylindrical doped region 218 of the resulting optical waveguide. The optical waveguide formed by the method 200 and illustrated in FIGS. 4C and 4D is one method of forming the optical waveguide 100 of the present invention.

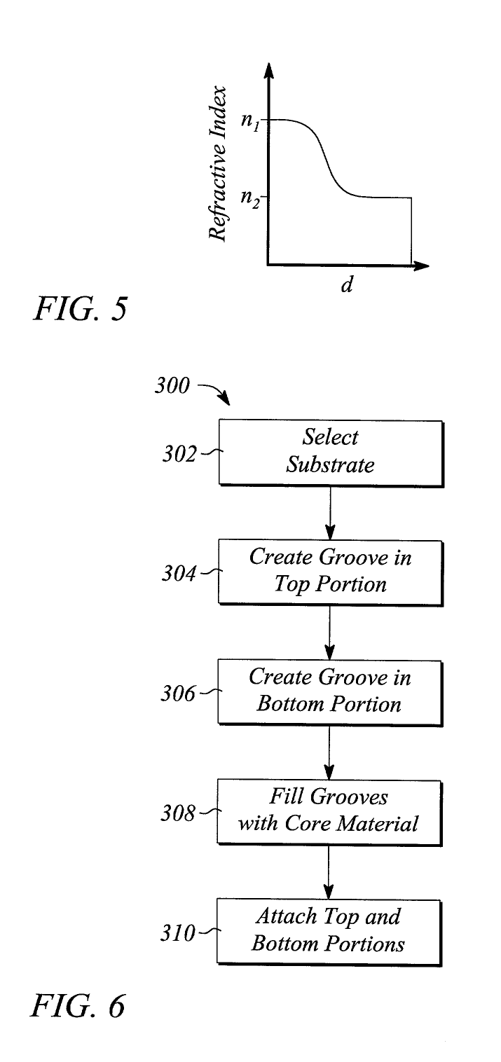

In practice, the refractive index n₁ of the cylindrical doped region or core 218 of the optical waveguide represents an average index of refraction. The step of diffusion 206 results in a dopant concentration that varies from a higher value near the center of the cylindrical core to a lower value near the edge of the cylindrical core. Therefore, a local index of refraction n₁(d) of the cylindrical core likewise varies as a function of distance d measured from the center of the cylindrical core. On the whole, the local index of refraction n₁(d) is found to vary from a higher value at the center of the cylindrical core to a lower value of at the edge of the cylindrical core. An index of refraction profile depicting the typical variation of the local index of refraction n₁(d) as a function of distance d from the center of the cylindrical core for the method 200 of the present invention is illustrated in FIG. 5. The cylindrical core optical waveguide created by the method 200 of the present invention is a graded-index optical waveguide.

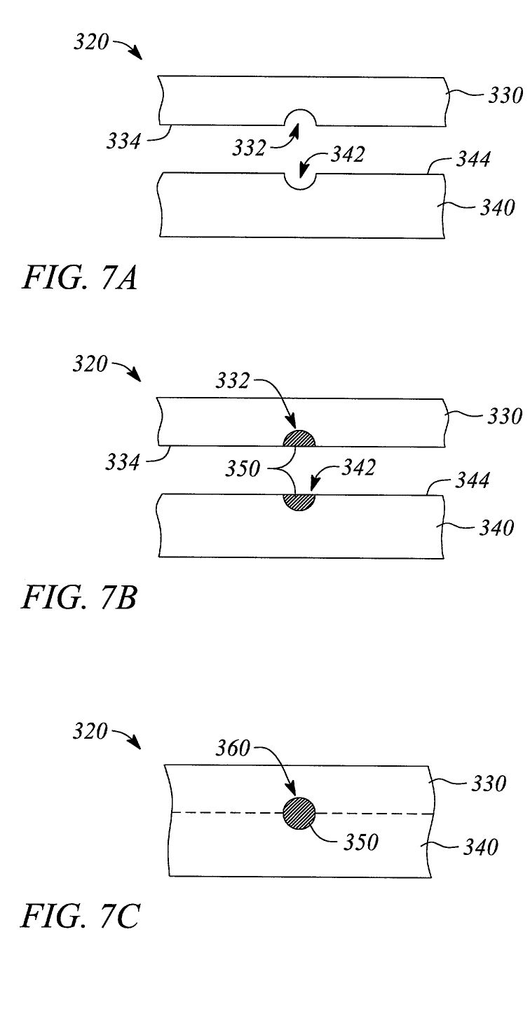

FIG. 6 illustrates a flow chart of another method 300 of forming a buried optical waveguide having a cylindrical core in a planar substrate in accordance with the present invention. The method 300 creates a buried cylindrical core optical waveguide that has a constant index of refraction n₁ through the diameter of the cylindrical core. The method 300 of forming a buried optical waveguide having a cylindrical core comprises the step of selecting 302 a substrate 320. The substrate 320 comprises a top or first portion 330 and a bottom or second portion 340 and is illustrated in FIGS. 7A through 7C. The top portion 330 and bottom portion 340 may be of the same material or may be of different materials. The material may be any material having acceptable optical properties, including those listed hereinabove, as well as various plastic materials known in the art to have acceptable optical properties. One skilled in the art is familiar with such materials used as substrates 320 for PLCs.

The method 300 of forming a buried optical waveguide further comprises the steps of creating 304 a semi-circular groove 332 in a bottom or first surface 334 of the top or first portion 330 and creating 306 a semi-circular groove 342 in a top or second surface 344 of the bottom or second portion 340 of the substrate 320. An example of the substrate 320 and the semi-circular grooves 332, 342 created 304, 306 in the top portion 330 and the bottom portion 340 is illustrated in cross section in FIG. 7A. The semi-circular grooves 332, 342 can be created 304, 306 for example, using isotropic etching of the top and bottom portions 330, 340 of the substrate 320, as well as other techniques to form semi-circular shaped grooves, discussed further below. Any conventional isotropic etching techniques that are known in the art, including but not limited to, hydrofluoric acid (HF) etching, may be used. These techniques, as well as other well-known techniques not mentioned herein, are all within the scope of the present invention.

The method 300 further comprises the step of filling 308 the semi-circular grooves 332, 342 with a core material 350. The core material 350 can be the same or different from the material of the substrate 320. If the core material 350 is the same as the substrate material, it is doped to produce an index of refraction n₁ that differs from the substrate material index of refraction n₂. As is well known in the art, the selection of the core index of refraction value n₁ and the substrate index of refraction value n₂ is a function of the core diameter and the operational mode (e.g., multimode or single mode) of the optical waveguide that is being formed.

The core material 350 may be doped using conventional doping methods and dopant materials known in the art, including but not limited to, using titanium dioxide (TiO₂). For example, dopants can be introduced into the core material 350 using ion implantation. Alternatively, various powders can be precisely pre-mixed and then melted together to form a material that has an appropriate index of refraction (i.e., dopant concentration) for the core material 350. Once the bulk material has been so formed, the bulk material can be used as a sputtering target, or as a source for another thin film deposition method known in the art, from which the core material 350 is deposited. For example, if a silicon dioxide substrate is used, a core of borosilicate or borophosphasilicate glass can be deposited as the core material 350. In yet another example methodology, a gas supply is controlled during plasma enhanced chemical vapor deposition (PECVD), thus producing the desired material composition for core material 350.

The grooves 332, 342 are filled 308 with the doped core material 350 using conventional deposition methods, including but not limited to, PECVD or various thin film methods, such as sputtering or evaporation, as mentioned above. Alternatively, the groove may be filled with a liquid material, such as a liquid polymer, that later hardens or is cured to form a rigid material. For example, a liquid form of acrylate that is cured through exposure to ultraviolet radiation or to heat can be used. Various thermoset plastics, as well as thermally or ultraviolet cured, optically transparent epoxies, can be used. Even a two-part, optically transparent epoxy could be used to fill the groove. The epoxy is mixed and applied in liquid form and then allowed to harden. The refractive index of the liquid material is controlled with the addition of a choice of liquid fill or dopant materials.

The above referenced doping methods, as well as other well-known doping methods not mentioned herein, are all within the scope of the present invention. Likewise, the above referenced deposition methods, as well as other well-known deposition methods not mentioned herein, are all within the scope of the present invention. FIG. 7B illustrates in cross section the substrate 320 in which the grooves 332, 342 have been filled with the core material 350 in accordance with the step of filling 308. Any excess core material 350 on surface 334, 344 is removed. Additionally, the surface 334, 344 and core material 350 may be polished or lapped if required to produce a smooth surface.

The method 300 further comprises the step of attaching 310 the top portion 330 of the substrate 320 to the bottom portion 340 of the substrate 320, such that the bottom surface 334 of the top portion 330 is placed in contact with the top surface 344 of the bottom portion 340 of the substrate 320 and the filled grooves 332, 342 are aligned together. The aligned, filled grooves 332, 342 form the cylindrical core 360 of the optical waveguide. FIG. 7C illustrates a cross section of the substrate 320 perpendicular to the optical path that shows the circular cross section of the formed cylindrical core 360 after the step of attaching 310. The top portion 330 can be attached to the bottom portion 330 using any conventional bonding method including, but not limited to, welding, fusing, fusion bonding (i.e. the application of high temperature along with pressure) or using an adhesive, such as an epoxy, with pressure and/or heat, or other radiation to cure the adhesive. Preferably, a method of attaching is chosen that does not introduce another material between the substrate portions or between the core halves that could affect the propagation properties.

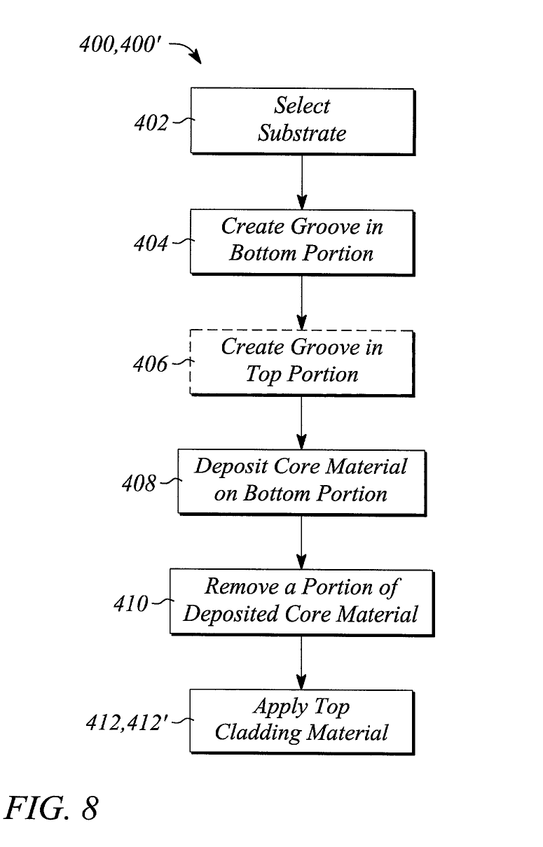

A flow chart of still another method 400 of forming a buried optical waveguide having a cylindrical core of the present invention is illustrated in FIG. 8. The method 400 has application to planar substrates that either have a top portion and a bottom portion, as described above for the method 300, or are formed by successively laying down material layers on a surface of a planar substrate.

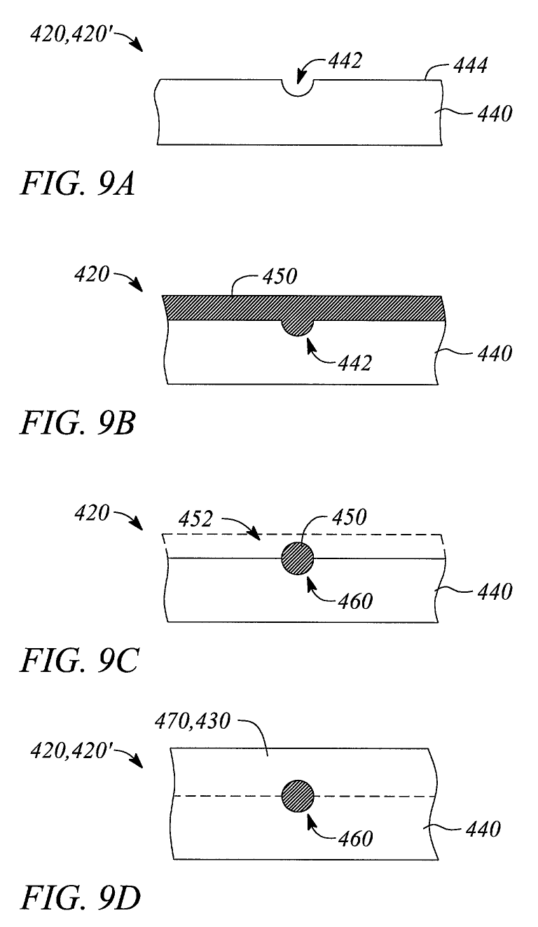

The method 400 comprises the step of selecting 402 a substrate 420. In the method 400, the substrate 420 has a surface 444. The method 400 further comprises the step of creating 404 a semi-circular groove 442 in the surface 444 of the substrate 420. The steps of selecting 402, and creating 404 are essentially the same as the steps of selecting 302, and creating 304, respectively, of the method 300. A substrate 420 having a semi-circular groove 442 created 404 in the surface 444 of the substrate 420 according to method 400 is illustrated in cross section in FIG. 9A.

The method 400 further comprises the step of depositing 408 a core material 450 on the surface 444 of the substrate 420. The step of depositing 408 fills the groove 442 in the substrate 420. In addition, the step of depositing 308 results in the accumulation of core material 450 on the surface 444 of the substrate 420, the thickness of the accumulation being greater than a radius a of the semi-circular groove 442. The core material 450 may be deposited 408 by one or more of any number of techniques including, but not limited to, molecular beam epitaxy (MBE), PECVD, evaporation deposition, liquid-phase coating, and screen-printing. These, as well as other conventional deposition techniques that are well known in the art, are all within the scope of the present invention. The choice of an appropriate deposition technique depends on the choice of the substrate 420 and core 450 materials. Given such a choice, one skilled in the art would readily be able to determine an appropriate deposition approach without undue experimentation. FIG. 9B illustrates in cross section the result of the step of depositing 408 the core material 450 on the surface 444 of the substrate 420.

The method 400 further comprises the step of removing 410 a portion 452 of the deposited core material 450 to form a cylindrical core 460. The step of removing 410 results in the cylindrical core 460, a lower or first half of which is in the groove 442 in the substrate 420, and an upper or second half of which is protruding out from the surface 444 of the substrate 420 at the groove 442 location. FIG. 9C illustrates in cross section the substrate 420 having the formed cylindrical core 460 after the step of removing 310. A dashed line in FIG. 9C illustrates the removed portion 452 of the deposited core material 450. The core material 450 is removed from the substrate 420 surface 444 by any one or more conventional methods including, but not limited to, various selective dry etching methods such as reactive ion etching (RIE) often used in forming microlenses in PLCs and related structures. These, as well as other conventional methods known in the art, are all within the scope of the present invention.

The method 400 further comprises the step of applying 412 a cladding layer 470 to at least cover the protruding portion of the cylindrical core 460. The step of applying 412 comprises forming a cladding layer 470 using one of several material deposition methods known in the art. For example, the cladding layer 470 may be deposited using a method such as evaporation deposition, PECVD, MBE, or screen-printing. The cladding layer 470 material may be the same or different than the material of the substrate 420. Preferably, the cladding material has the same index of refraction n₂ as the substrate 420.

In an alternate embodiment of the method 400′, the substrate 420′ may be essentially the same as the substrate 320, having bottom portion 440 and a top portion 430, as described above for the method 300. In this alternate embodiment, the method 400′ further comprises the step of creating 406 a semi-circular groove 432 (not shown) in a surface of the top portion 430 of the substrate 420′. The step of creating 406 is illustrated as a dashed box in FIG. 8 to indicate that it is an optional step. The optional step of creating 406 applies only if the substrate 420′, having top and bottom portions, is being used. Furthermore, in this alternate embodiment, the step of applying 412′ a cladding layer 470 comprises attaching the top portion 430 of the substrate 420′ to the bottom portion 440, such that the protruding core 460 fits into the groove 432 formed in the surface of the optional top portion 430. FIG. 9D illustrates a cross section through the substrate 420, 420′ following the step of applying 412, 412′ in accordance with the present invention.

The semi-circular grooves 332, 342, 432, 442 can be created using a variety of techniques. The choice of a specific technique for creating the grooves depends, in part, on the choice of substrate material and core material. One technique mentioned hereinabove is isotropic etching for forming the grooves. Another technique forms the grooves in the substrate using a molding process. Further, mechanical machining or milling; gouging or scratching the surface with a diamond-tipped stylus or probe; or laser ablation can also be used to form the grooves. One skilled in the art can readily determine other techniques for creating semi-circular grooves in specific substrate materials and for specific applications without undue experimentation. All such methods are within the scope of the present invention. For example, emerging microelectromechanical systems (MEMS) technology, as well as conventional mechanical machining, can be used for the present invention.

Advantageously, the cross sectional shape of the optical waveguide 100 formed by methods 300 and 400 can be varied along the optical path of the optical waveguide in the PLC. For example, the optical waveguide 100 may have a circular cross section at the edges or ends of a PLC to facilitate interfacing the optical waveguide with optical fibers. At other places along the optical path, the optical waveguide may have one or more of a conventionally square or conventionally rectangular cross section to facilitate interfacing with optical components or for the implementation of an optical element such as a coupler.

In another aspect, the optical waveguide 100 serves as a transition or ‘mode transformer’ to facilitate interfacing a PLC waveguide having a core with a noncircular cross section to an optical waveguide such as an optical fiber having a circular cross section. When implementing a mode transformer, the optical waveguide 100 comprises a core 110 having a circular cross section at a first or interface end and a non-circular cross section at a second end. At the first end, the optical waveguide 100 provides an optical mode match to an optical fiber. At the second end, the non-circular cross section is adapted to provide an optical mode match to a non-circular PLC optical guide. Between the first and second ends, the core 110 transitions, preferably smoothly, from the circular cross section to the noncircular cross section, respectively.

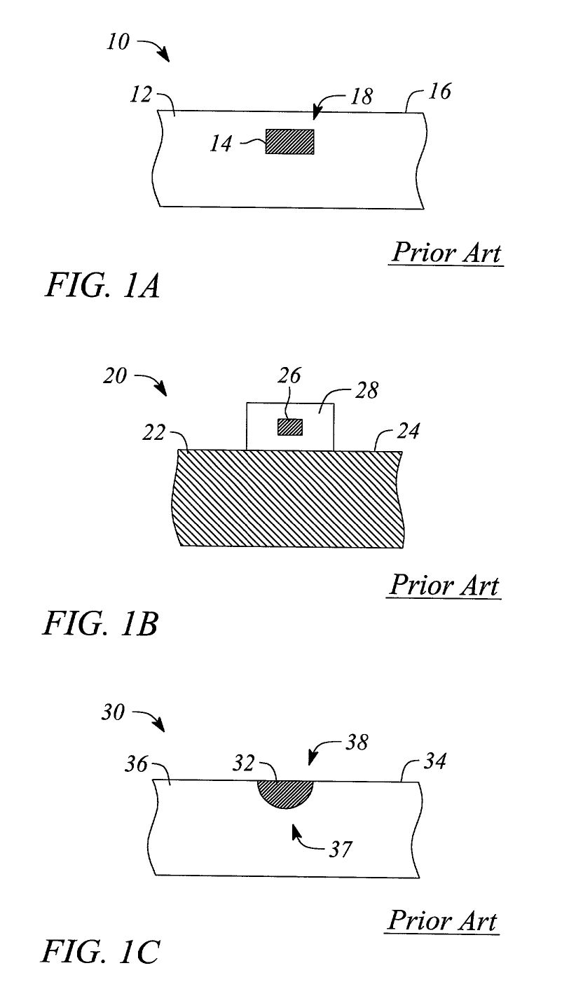

For example, PLCs using LiNbO₃ technology often employ optical guides having a semi-circular core cross section, such as is illustrated in FIG. 1C. The semi-circular cross section of such a guide, given the relatively high index of refraction of LiNbO₃ substrates, produces a guided optical signal or wave having highly distorted, largely non-circular shaped optical modes. The non-circular shaped optical modes do not match well with the circularly shaped optical modes of an optical fiber. The optical waveguide 100 of the present invention can serve as a transition from the semi-circular cross section of the LiNbO₃ PLC optical guide to the circular cross section of the optical fiber. Such a transition essentially transforms the non-circular modes of the LiNbO3 optical waveguide to the circular modes of the optical fiber and therefore, is properly termed a ‘mode transformer’.

Advantageously, optical waveguides 100 of the present invention having a core shape that varies from cylindrical to non-cylindrical can be created by methods 300 and 400, 400′, and to a limited extent, by method 200 of the present invention. For example, method 400, 400′ is especially well suited to creating core having varying cross sectional shapes along its length such as is used in the mode transformer. Additionally, varying the cross sectional shape of the core can be useful in various other optical wave-guiding applications associated with PLCs. These, as well as other combinations or variations in cross sectional shapes not mentioned herein, are within the scope of the present invention.

Thus, there has been described a novel optical waveguide 100 and novel methods 200, 300, and 400, 400′ for producing a optical waveguide 100 having a cylindrical core that is applicable to a planar lightwave circuit (PLC). It should be understood that the above-described embodiments are merely illustrative of the some of the many specific embodiments that represent the principles of the present invention. Clearly, those skilled in the art can readily devise numerous other arrangements without departing from the scope of the present invention as defined in the following claims.

What is claimed is:

1. A planar lightwave circuit optical device comprising:
a planar substrate having a peripheral index of refraction; and
an optical waveguide formed in the planar substrate, the waveguide having a core with a cross section that is more circular than rectangular, the waveguide having a core index of refraction that is greater than the peripheral index of refraction.

2. The optical device of claim 1, wherein the waveguide is a graded-index optical waveguide.

3. The optical device of claim 1, wherein the core index of refraction is a variable index of refraction.

4. The optical device of claim 1, wherein the waveguide is a step-index optical waveguide.

5. The optical device of claim 1, wherein the core index of refraction is uniform throughout the optical waveguide.

6. The optical device of claim 1, wherein the substrate comprises a homogenous cladding region around the core.

7. The optical device of claim 1, wherein only a portion of the core has a cross section that is more circular than rectangular.

8. The optical device of claim 7, wherein the portion of the core that has a cross section that is more circular than rectangular is adjacent to an end of the optical waveguide that is adapted for interfacing to an optical fiber.

9. A method for making an optical waveguide in a planar substrate, the method comprising:
forming a waveguide core having a cross section that is more circular than rectangular within the planar substrate such that the waveguide core has an index of refraction that is higher than an index of refraction in a cladding region of the planar substrate, the cladding region surrounding the core.

10. The method of claim 9, wherein the step of forming comprises:
implanting a dopant into the planar substrate; and
diffusing the dopant so as to produce the waveguide core.

11. The method of claim 10, wherein the core index of refraction comprises a variable index of refraction.

12. The method of claim 10, wherein the optical waveguide is a graded-index optical waveguide.

13. The method of claim 10, wherein the substrate comprises a homogenous cladding region around the core.

14. The method of claim 9, wherein the step of forming a waveguide core comprises:
forming a groove having a radius in a portion of the planar substrate; and
filling the substrate groove with a material so as to form the waveguide core, the material having the core index of refraction.

15. The method of claim 14, wherein the core index of refraction is uniform throughout the cross section.

16. The method of claim 14, wherein the optical waveguide is a step-index optical guide.

17. The method of claim 14, wherein the step of forming a waveguide core further comprises:
overfilling the substrate groove with the material; and
shaping the overfill material so that the core attains the cross section that is more circular than rectangular.

18. The method of claim 17, wherein the step of forming a waveguide core further comprises:
creating a groove in a second portion of the planar substrate, the second portion groove having at least the radius; and
attaching the second portion to the first-mentioned substrate portion, such that the groove in the second portion is aligned to enclose the shaped-overfill core material.

19. The method of claim 17, wherein the shaped-overfill core material has a radius similar to the groove radius in the first substrate portion.

20. The method of claim 18, wherein the first substrate portion and the second substrate portion have the cladding region index of refraction.

21. The method of claim 17, wherein the step of forming a waveguide core further comprises:
forming a groove in a second portion of the planar substrate, the second portion groove having a radius similar to the radius of the first-mentioned groove;
filling the second portion groove with the material; and
mating the second substrate portion and the first-mentioned substrate portion so as to align the respective filled grooves such that the core attains the cross section that is more circular than rectangular.

22. The method of claim 21, wherein the first substrate portion and the second substrate portion provide a homogenous cladding region around the core.

23. An optical mode transforming device comprising:
a planar substrate having a peripheral index of refraction;
an optical waveguide formed in the planar substrate, the waveguide having a core that transitions in cross sectional shape from being more circular than rectangular at a first end to being less circular than rectangular at a second end, the waveguide core having a core index of refraction that is greater than the peripheral index of refraction.
